(19) United States
(12) Patent Application Publication
(10) Pub. No.: US 2007/0269731 A1
(43) Pub. Date: Nov. 22, 2007

(54) Method of preparing toner and toner prepared using the method

(75) Inventors: Min-young Cheong, Seoul (KR); Sang-soon Lim, Seocheon-gun (KR); Kyung-yol Yon, Seongnam-si (KR); Chang-kook Hong, Suwon-si (KR); Yo-da Shin, Incheon (KR); Su-bum Park, Daegu (KR); Hyun-ju Kim, Ansan-si (KR); Seong-hwan Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/643,919

(22) Filed: Dec. 22, 2006

(30) Foreign Application Priority Data
May 19, 2006 (KR) 10-2006-0045111

(51) Int. Cl. G03G 9/087; G03G 9/00

(52) U.S. Cl. 430/109.3; 430/137.14; 430/137.17; 430/123.5

(57) ABSTRACT

A method of manufacturing toner uses a simplified process, in which the use of a surfacant is reduced to minimize the amount of wastewater generated. The toner manufactured using the method, an image forming method using the toner, and an image forming apparatus employing the toner are also provided.

### CROSS-REFERENCE TO RELATED PATENT APPLICATION

This application claims the benefit under 35 U.S.C. §119(a) of Korean Patent Application No. 10-2006-0045111, filed on May 19, 2006 in the Korean Intellectual Property Office, the disclosure of which is hereby incorporated by reference in its entirety.

### BACKGROUND OF THE INVENTION

1. Field of the Invention

The present invention relates to a method of manufacturing toner and to the toner manufactured using the method. More particularly, the invention relates to a method of preparing toner using a simplified process, in which the amount of a surfactant used in the process is reduced to minimize the amount of generated wastewater. The invention also provides a method of forming an image, and an image forming apparatus employing the toner.

2. Description of the Related Art

In an electrophotographic process or an electrostatic recording process, a developer used to form an electrostatic image or an electrostatic latent image may be a two-component developer, formed of a toner and carrier particles, or a one-component developer, formed only of a toner. The one-component developer may be a magnetic one-component developer having magnetic properties or a nonmagnetic one-component developer having no magnetic properties. Plasticizers such as colloidal silica are often added independently into the nonmagnetic one-component developer to increase the flowability of the toner. Generally, colorants, such as carbon black, or other additives in a binder resin are used in the toner.

Methods of preparing toners include pulverization method or polymerization methods. In the pulverization method, the toner is obtained by melting and mixing synthetic resins with colorants and, if needed, other additives. The mixture is pulverized and the particles are sorted until particles of a desired size are obtained. In the polymerization method, a polymerizable monomer composition is manufactured by uniformly dissolving or dispersing a polymerizable monomer, a colorant, a polymerization initiator and, if needed, various additives such as a cross-linking agent and an antistatic agent. Next, the polymerizable monomer composition is dispersed in an aqueous dispersive medium which includes a dispersion stabilizer using an agitator to form minute liquid droplet particles. Subsequently, the temperature is increased and suspension polymerization is performed to obtain a polymerized toner having coloring polymer particles of a desired size.

In an image forming apparatus such as an electrophotographic apparatus or an electrostatic recording apparatus, an electrostatic latent image is formed by exposing light to the surface of a photoreceptor which is uniformly charged. A toner is attached to the electrostatic latent image, and a resulting toner image is transferred to a transfer medium such as a sheet of paper and fixed on the transfer medium through several processes such as heating, pressing, solvent steaming, and the like. In most fixing processes, the transfer medium with the toner image passes through fixing rollers and pressing rollers, and by heating and pressing the toner image is fused to the transfer medium.

Images formed by an image forming apparatus such as a photocopier should satisfy requirements of high precision and accuracy. Conventionally, a toner used in an image forming apparatus is usually obtained using a pulverization method. When using a pulverization method, color particles having a large range of sizes are formed. Hence, to obtain satisfactory developer properties, there is a need to sort the coloring particles obtained by the pulverization according to size to reduce the particle size distribution. However, it is difficult to precisely control the particle size distribution using a conventional mixing/pulverizing process in the manufacture of toner particles suitable for an electrophotographic process or an electrostatic recording process. Also, when preparing a minute particle toner, a toner preparation yield is low due to the corresponding sorting process required. In addition, there are limitations in adjusting toner designs for obtaining desirable charging and fixing properties. Accordingly, polymerized toners, in which the size of particles is easy to control and which do not need to go through a complex manufacturing process including sorting, have recently come into the spotlight.

When a toner is prepared using the above described polymerization method, a desired size distribution of particles can be obtained without pulverization or sorting. However, in the polymerization method, a surfactant for dispersing pigments is used, and the use of a surfactant requires a washing process, thereby increasing the manufacturing costs and the amount of generated wastewater.

For example, U.S. Pat. No. 6,258,911 to Georges et al. discloses “Bifunctional macromolecules and toner compositions therefrom”, having a narrow polydispersity and a method of emulsification-aggregation polymerization which prepares a polymer having free radicals that are covalent-bonded at both ends of the polymer. In such a method of preparing toner using emulsification-aggregation polymerization, an ionic surfactant (in general, a cationic surfactant) is used to separately prepare wax and pigment dispersions. Polymer latex particles are prepared using a surfactant dispersed together with the wax dispersion and the pigment dispersion, thereby providing toner particles through an aggregation process. Alternatively, polymer latex particles (or seeds) are polymerized primarily, and then the seeds are polymerized by a wax-monomer emulsification dispersion and by emulsion polymerization, which is treated with seed, and then is aggregated using a pigment dispersion which is dispersed using a surfactant in an aggregating process, thereby providing toner particles. However, the process of such a method of preparing toner using the conventional emulsification-aggregation method is complicated, and it is difficult to remove the used surfactant, and if the surfactant remains, various problems arise. In particular, additional processes such as washing process of the toner are required, which pollute the environment and decrease economical efficiency.

### SUMMARY OF THE INVENTION

The present invention provides a method of preparing toner using a simplified process, in which the amount of the surfactant used in the method is reduced, thereby minimizing the amount of wastewater.

The present invention also provides a toner which is prepared using the above method.

The present invention also provides a toner having excellent storability and durability.

The method of the invention is able to easily control the size of the particles produced.

The present invention also provides a method of forming an image having high image quality and which can be fixed at a low temperature by using the toner of the invention having excellent storability and durability, and having a specifically defined particle size.

The present invention also provides an image forming apparatus in which a high quality image can be fixed at a low temperature by employing the toner of the invention having excellent storability and durability, and having a specifically defined particle size.

According to an aspect of the present invention, a method of manufacturing a toner comprises: manufacturing polymer latex particles by polymerizing a toner composition including a macromonomer having a hydrophilic group, a hydrophobic group, and at least one reactive functional group, and at least one polymerizable monomer; manufacturing core particles by aggregating the polymer latex particles; forming a wax layer on the core particles by coating the core particles with a dispersion solution that comprises at least one polymerizable monomer and a wax; forming a pigment dispersion solution by dispersing a pigment using the polymer latex particles having the wax layer; and aggregating the pigment dispersion solution.

According to another aspect of the present invention, a toner is obtained by polymerizing a toner composition including a macromonomer to manufacture polymer latex particles, the macromonomer having a hydrophilic group, a hydrophobic group, and at least one reactive functional group, and at least one polymerizable monomer, aggregating the polymer latex particles to obtain core particles, coating the core particles with a dispersion solution to form a wax layer thereon, the dispersion solution including polymerizable monomers and a wax, and forming a dispersion solution by dispersing a pigment using the polymer latex particles which includes a wax layer and aggregating the pigment to obtain the toner.

According to another aspect of the present invention, an image forming apparatus comprises: an organic photoreceptive body, a unit for charging a surface of the organic photoreceptive body, a unit for forming a latent image on the surface of the organic photoreceptive body, a unit for receiving a toner, a unit for developing the toned image by developing a latent image on the surface of the organic photoreceptive body by supplying the toner, and a unit for transferring the toner image from the surface of the photoreceptive body to a transferring member, wherein the toner is a toner manufactured using the method comprising: manufacturing polymer latex particles by polymerizing a toner composition including a macromonomer having a hydrophilic group, a hydrophobic group, and at least one reactive functional group, and at least one polymerizable monomer; manufacturing core particles by aggregating the polymer latex particles; forming a wax layer on the core particles by coating the core particles with a dispersion solution that comprises at least one polymerizable monomer and a wax; forming a pigment dispersion solution by dispersing pigment using polymer latex particles which include the wax layer; and aggregating the pigment dispersion solution.

### BRIEF DESCRIPTION OF THE DRAWING

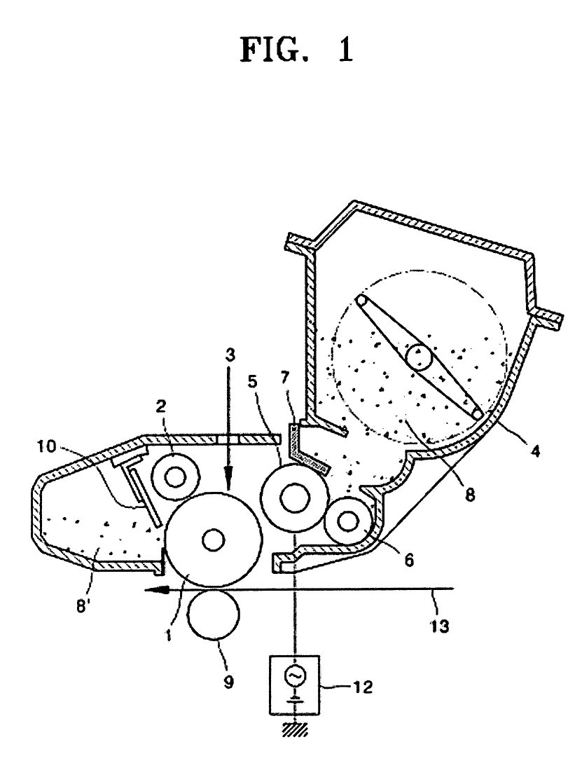

The above and other features and advantages of the present invention will become more apparent by describing in detail exemplary embodiments thereof with reference to FIG. 1 which illustrates an image forming apparatus employing a toner prepared according to the present invention.

### DETAILED DESCRIPTION OF THE INVENTION

The present invention will now be described in more detail.

The present invention provides a method of preparing toner. The method is a simple process and reduces the amount of surfactant used in the process, thereby minimizing the amount of generated wastewater. In particular, polymer latex particles are formed with a hydrophilic group and hydrophobic group and therefore can be used to disperse a pigment. Thus, the ability of the polymer latex to disperse the pigment is maintained while the amount of the surfactant used can be significantly reduced. Accordingly, problems caused by overuse of a surfactant can be solved.

The latex polymer particles in one embodiment are prepared by an emulsion polymerization process where the reaction medium is substantially in the absence of an emulsifier. The toner particles are also prepared substantially in the absence of an emulsifier. The latex polymer particles are prepared using a macromonomer having hydrophilic and hydrophobic groups and at least one reactive functional group. The resulting latex polymer particles are able to form the core-shell structure of the toner in the absence of a surfactant.

The toner according to the present invention has a core-shell structure, where core particles are not obtained by using a surfactant. The core-shell structure is obtained using a method in which polymer latex particles are first prepared using a radical polymerization method and core particles of a desired size and shape are obtained through an aggregation process. The molecular weight, glass transition temperature (Tg) and the rheological features of the obtained core particles of the toner should be controlled to have the ability of being fixed at a low temperature.

In one embodiment, the toner is produced by polymerizing a polymerizable toner composition to obtain polymer latex particles, where the polymer latex has hydrophilic regions and hydrophobic regions. The polymer latex particles are aggregated, preferably in the absence of an emulsifier to obtain core particles. A wax layer is then is then formed on the core particles and the core particles are dispersed with a pigment in a solution. The pigment dispersion is aggregated to obtain the toner particles. The toner composition can include at least one polymerizable monomer and a macromonomer having a hydrophobic group, a hydrophilic group and at least one functional reactive group. The wax layer is formed by mixing the core particles with a wax dispersion of at least one polymerizable monomer and a wax.

The rheological features of the core particles are determined by complex modulus by a dynamic test by measuring the storage modulus G′ and loss modulus G″. The rheological properties can also be adjusted by the complex viscosity. Also, the relaxation modulus of elasticity and relaxation time of the core particles can be measured. Such stress-relaxation behavior is affected by the molecular weight and structure of the toner binder and the content of the wax contained in the toner. When the complex viscosity is too low (1.0×10² Pas or less), offset or peeling failure occurs in a corresponding fixing unit. When the complex viscosity is too high (1.0×10⁴ Pas or greater), the adhesion property during fixing is not good, and glossiness is reduced, and the toner cannot be easily supplied to the paper.

Meanwhile, when the weight average molecular weight Mw of the binder resin is adjusted to be 30,000 or less, the Tg is set to be about 50° C., and the rheological properties are lowered in order to improve low temperature fixing properties. The fixing properties can be increased, but problems such as offset occurs. To solve this problem, the reactivity of the macromonomers participating in the polymerization is adjusted to slightly cross-link the resin. However, problems such as decrease in durability are not thoroughly solved, and thus in order to improve durability of the toner and to solve the storability of the toner in shipping and handling, the toner is formed encapsulated by a shell layer.

A polymerization inhibitor is added so that no new polymer latex particles are created. The reaction is preferably performed in a starved-feeding condition so that the monomer mixed solution can be properly coated on the toner.

In the present invention, since the macromonomers used as comonomers in the latex polymerization process maintain the stability of the latex in aqueous solution, a surfactant is not used in the preparation process and the aggregation process of the polymer latex particles.

The macromonomers used in the present invention are amphiphilic materials having both a hydrophilic group and hydrophobic group, and are in the form of a polymer or an oligomer having at least one reactive functional group at one end.

The hydrophilic group of the macromonomers which is combined on the surface of the polymer latex particles increases the long-term stability of the polymer latex particles by steric stabilization, and can adjust the size of the polymer latex particles according to the content or molecular weight of the injected macromonomers. The hydrophobic group of the macromonomers exist on the surface of the toner particles and can facilitate an emulsification polymerization reaction. Macromonomers can form copolymers with polymerizable monomers contained in the compositions by being bonded by grafting, branching, or cross-linking.

The weight average molecular weight of the macromonomers according to the present invention may be about 100 to 100,000, preferably about 1000 to 10,000. When the weight average molecular weight of the macromonomers is less than 100, the properties of the obtained toner are not improved or the macromonomers cannot function well as a stabilizer. When the weight average molecular weight of the macromonomers is greater than 100,000, the reaction conversion rate may be lowered.

The macromonomers may be selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol(PEG)-hydroxyethylmethacrylate, hexa functional polyester acrylate, dendritic polyester acrylate, carboxy polyester acrylate, fatty acid modified epoxy acrylate, and polyester methacrylate, but is not limited thereto.

When the content of the macromonomers is less than 1 part by weight based on 100 parts by weight of the toner composition, the dispersion stability of the particles is reduced, and when the content of the macromonomers is greater than 50 parts by weight, the properties of the toner deteriorate.

Amphiphilic macromonomers can function not only as copolymers but also as a stabilizer. Initial reaction of radicals and monomers creates oligomer radicals and shows an in situ stabilization effect. An initiator dissolved by heating creates radicals and reacts with a monomer in an aqueous solution and the hydrophobicity of the oligomer radicals increases. Such hydrophobicity of the oligomer radical facilitates diffusion into the imicelle and the reaction with the polymerizable monomers, which results in a copolymerization reaction with macromonomers.

Due to the hydrophilicity of the amphiphilic macromonomers, copolymerization can easily occur in the vicinity of the surface of the toner particles. The hydrophilic portion of the macromonomers located on the surface of the particles increases the stability of the toner particles by steric stability, and the size of the particles can be adjusted according to the content or molecular weight of the macromonomers. Also, functional groups reacting on the surface of the particles can improve the frictional electricity of the toner.

The polymerizable monomer according to the present invention can be selected from a vinyl monomer, a polar monomer having a carboxylic group, a monomer having an unsaturated polyester, and a monomer having a fatty acid group.

The polymerizable monomer includes at least one selected from the group consisting of a styrene monomer such as styrene, vinyl toluene, and α-methyl styrene; derivatives of (meth)acrylates such as acrylic acid, methacrylic acid, methyl acrylate, ethyl acrylate, propyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide, and the like; ethylenic unsaturated monoolefins such as ethylene, propylene, butylene, and the like; halogenized vinyls such as vinyl chloride, vinylidene chloride, fluorinated vinyl, and the like; vinyl esters such as vinyl acetate, vinyl propionate, and the like; vinyl ethers such as vinyl methyl ether, vinyl ethyl ether, and the like; vinyl ketones such as methyl vinyl ketone, methyl isoprophenyl ketone, and the like; and nitrogen-containing vinyl compounds such as 2-vinylpyridine, 4-vinylpyridine, and N-vinyl pyrolidone, and the like, but is not limited thereto.

The content of the polymerizable monomer may be about 3 to 50 parts by weight based on 100 parts by weight of the total content of the toner composition. When the content of the polymerizable monomer is less than 3 parts by weight based on 100 parts by weight of the total content of the toner composition, the yield is reduced. When the content of the polymerizable monomer is greater than 50 parts by weight, the stability is reduced.

A medium that can be used in the present invention may be an aqueous solution, an organic solvent, or a mixture of these.

The detailed process of manufacturing cores of the polymerization toner and shells coating the cores is as follows.

First, a toner composition including the above described macromonomer and at least one polymerizable monomer is polymerized to manufacture polymer latex particles. In detail, the inside of the reactor is purged using nitrogen gas, and a mixture of a medium such as distilled deionized water (or a mixture of water and an organic solvent) and a macromonomer is fed to the reactor and heated by agitating. An electrolyte or inorganic salt such as NaOH or NaCl can be added to adjust the ionic intensity of the medium. When the temperature inside the reactor approaches an appropriate level, an initiator, preferably a water soluble free radical initiator, may be added. Then, at least one polymerizable monomer, preferably with a chain transfer agent may be gradually added to the reactor in a semi continuous way. The polymerizable monomer is preferably slowly supplied by a starved feeding process in order to control the reaction speed and dispersion degree.

The polymerization time is about 6 to 12 hours and is determined by the temperature and experiment conditions, and by measuring the reaction speed and the conversion rate, and other variables. After the reaction, a monomer may be additionally introduced to adjust the durability or other properties of the toner to manufacture polymer latex particles. The polymer latex particles manufactured in this way are aggregated to form cores.

In the present invention, a wax layer is formed in the core particles aggregated in this manner. A wax layer is formed by introducing the dispersion solution which is obtained by dispersing wax in a mixed solution in which at least one polymerizable monomer as described above is mixed in a solvent into a reactor in which the core particles are formed and by adding an initiator, and other additives. After a wax layer is formed, at least one polymerizable monomer is added to the reactor to form a final shell layer on the surface of the core particles to obtain the desired polymer latex particles. Here, a polymerization inhibitor may be added so that no new polymer latex particles are created. Also, the reaction may be processed in a starved feeding fashion such that a polymerizable monomer mixed solution is properly coated on the core particles.

After polymer latex particles having a core-shell structure including a wax are manufactured, pigments can be dispersed using the polymer latex particles. This is because the polymer latex particles have both hydrophilicity and hydrophobicity and thus dispersion ability is maintained. The dispersion apparatus that can be used here may be a milling or a homogenizer and other devices, without limitation, and the size and shape of the toner of the pigment dispersion solution obtained as such can be adjusted through an aggregation process. After desired size and shape of the toner is obtained, this is filtered to separate and dry the toner. The dried toner is treated with an external additive using silica or the like, and the charge amount is adjusted to obtain a final dry toner.

The manufacturing process of the polymer latex particles does not use a surfactant, thereby minimizing the washing process during the separation and filtering process of the manufactured toner particles. As the washing process is minimized, the manufacturing process is simplified, thereby reducing the manufacturing costs of the toner and reducing the amount of discharged wastewater, which is advantageous from an environmental aspect. Also, since no surfactant is used, problems such as sensitivity at high humidity, low friction charge, reduction in dielectric constant, weak toner flow, and the like, can be eliminated, and the storage ability of the toner can be preeminently increased.

Since the toner according to the present invention as described above can contain a pigment, carbon black or aniline black can be used as a pigment for black toner. A nonmagnetic toner according to the present invention is advantageous for preparing a color toner. In the case of color toner, at least one color selected from yellow, magenta, and cyan pigments can be used.

For the yellow pigment, condensation nitrogen compound, isoindolinone compound, anthraquinone compound, azo metal complex, or alyl imide compound can be used. For example, C.I. pigment yellow 12, 13, 14, 17, 62, 74, 83, 93, 94, 95, 109, 110, 111, 128, 129, 147, 168, 180, and the like can be used.

For the magenta pigment, condensation nitrogen compound, anthraquinone, quinacridone compound, basic dye rate compound, naphthol compound, benzo imidazole compound, thioindigo compound, or perylene compound can be used. For example, C.I. pigment red 2, 3, 5, 6, 7, 23, 48:2, 48:3, 48:4, 57:1, 81:1, 122, 144, 146, 166, 169, 177, 184, 185, 202, 206, 220, 221, or 254, and the like can be used.

For the cyan pigment, copper phthlaocyanine compound and derivatives thereof, anthraquinone compound, or basic dye rate compound can be used. For example, C.I. pigment blue 1, 7, 15, 15:1, 15:2, 15:3, 15:4, 60, 62, 66, and the like can be used.

Such pigments can be used alone or in combination, and is selected in consideration of color, chromacity, luminance, resistance to weather, dispersion property in toner, and the like.

The content of the pigment as described above is preferably about 0.1 to 20 parts by weight, based on 100 parts by weight of the polymerizable monomer.

The content of the pigment is appropriate when the content is enough to color the toner, however, when the content of the pigment is less than 0.1 parts by weight based on 100 parts by weight of the polymerizable monomer, the coloring effect is not sufficient. When the content of the pigment is greater than 20 parts by weight, the manufacturing costs of the toner increases, and sufficient frictional charge amount cannot be obtained.

The wax formed on the core particles may be any wax that provides a required performance for the final toner composition. Examples of the wax that can be used include polyethylene-based wax, polypropylene-based wax, silicone wax, paraffin-based wax, ester-based wax, carbauna wax and, metallocene wax, but are not limited thereto. The melting point of the wax is preferably about 50° C. to about 150° C. The wax constituent is physically attached to the toner particles, but is preferably not covalently bonded with toner particles. Thus, a toner that is fixed at a low fixing temperature on a final image receptor and shows excellent final image durability and resistance to abrasion is provided.

The toner according to the present invention may additionally include at least one initiator, a chain transfer agent, a release agent, and a charge control agent.

In the above manufacturing process, the toner composition may have radicals generated by an initiator, and the radicals may react with the polymerizable monomer. The radicals can react with reactive functional groups of the polymerizable monomer and the macromonomer to form copolymers.

Examples of the radical initiator are persulfated salts such as potassium persulfate, ammonium persulfate, and the like; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, 1,1′-azobis(1-cyclohexanecarbonitrile) and the like; and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, di-t-butylperoxy isophthalate, and the like. Also, an oxidization-reduction initiator in which the polymerization initiator and reduction agent are combined may be used.

A chain transfer agent refers to a material that facilitates to change the type of the chain transfer material in a chain reaction. The chain transfer agent includes a material that significantly reduces activity of a chain compared to that of a previous chain. The polymerization of the monomer can be reduced and a new chain can be initiated by a chain transfer agent. The distribution of the molecular weight can be adjusted by a chain transfer agent.

Examples of the chain transfer agent are sulfur containing compounds such as dodecanthiol, thioglycolic acid, thioacetic acid, and mercaptoethanol; phosphorous acid compounds such as phosphorous acid and phosphorous sodium; hypophosphorous acid compounds such as hypophosphorous acid and hypophosphorous sodium; and alcohols such as methyl alcohol, ethyl alcohol, isopropyl alcohol, and n-butyl alcohol, but are not limited thereto.

The release agent can be used to protect a photoreceptor and prevent deterioration of developing, thereby obtaining a high quality image. A release agent according to the present invention may be a high purity solid fatty acid ester material. Examples of the release agent are low molecular weight polyolefins such as low molecular weight polyethylene, low molecular weight polypropylene, low molecular weight polybutylenes, and the like; paraffin wax: multi-functional ester compound, and other suitable compounds. The release agent used in the present invention may be a multifunctional ester compound composed of an alcohol having three or more functional groups and a carboxylic acid.

Examples of the multifunctional alcohol having three or more functional groups are aliphatic alcohols such as glycerin, pentaerythritol, pentaglycerol, and the like; alicyclic alcohols such as chloroglycitol, xylitol, inositol, and the like; aromatic alcohols such as tris(hydroxymethyl)benzene, and the like; sugars such as d-erythrose, l-arabinose, d-mannose, d-galactose, d-fructose, l-ramunose, saccharose, maltose, lactose and the like; sugar alcohols such as erythrite, d-threite, l-arabite, and the like.

Examples of the carboxylic acid, and an example of the release agent, include aliphatic carboxylic acids such as acetic acid, butyric acid, caproic acid, enanthic acid, caprylic acid, perargonic acid, capric acid, undecanoic acid, lauric acid, myristic acid, stearic acid, margaric acid, arachidic acid, cerotic acid, merichisinic acid, elikanic acid, buracydinic acid, sorbic acid, linoleic acid, linolenic acid, behenic acid, tetrolic acid; aromatic caboxylic acids such as cyclohexanecarboxlic acid, hexahydroisophthalic acid, hexahydroterephthalic acid, 3,4,5,6-tetrahydrophthalic acid, and the like; alicyclic carboxylic acid such as benzoic acid, truxillic acid, cuminic acid, phthalic acid, isophthalic acid, terephthalic acid, trimesic acid, trimellitic acid, hemimellitic acid, and the like.

The charge control agent may be selected from the group consisting of a salicylic acid compound containing a metal, such as zinc or aluminum, boron complex of bis diphenyl glycolic acid, and silicate. For example, dialkyl salicylic acid zinc, {boro bis(1,1-diphenyl-1-oxo-acetyl potassium salt)}, and the like can be used.

According to another aspect of the present invention, a toner is obtained by polymerizing a toner composition including a macromonomer to manufacture polymer latex particles where the macromonomer has a hydrophilic group and hydrophobic group and at least one reactive functional group, and at least one polymerizable monomer. The polymer latex particles are aggregated to obtain core particles. The core particles are coated with a dispersion solution to form a wax layer thereon. The dispersion solution includes polymerizable monomers and a wax dispersed therein. A dispersion solution is formed by dispersing a pigment using the polymer latex particles which includes a wax layer and aggregating the pigment to obtain the toner.

The toner is preferably prepared without the presence of a surfactant during the manufacturing process of polymer latex particles and the aggregating process of the polymer latex particles. Details of the processes are as described above. The average diameter of the manufactured tone particles is about 0.5 to 20 μm, preferably about 5 to 10 μm.

The radicals created by an initiator react with the polymerizable monomers, or the radicals react with the reactive functional groups of the polymerizable monomer and the macromonomers to form a copolymer. The copolymer can be obtained by copolymerizing at least one monomer selected from vinyl monomer, a polar monomer having a carboxylic group, a monomer having an unsaturated polyester group, and a monomer having a fatty acid. Also, the weight average molecular weight of the obtained copolymer is preferably about 2,000 to 200,000.

The weight average molecular weight of the macromonomer is about 100 to 100,000, preferably about 1,000 to 10,000. Examples of the macromonomer are polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide(PAM), polyethylene glycol (PEG)-hydroxyethylmethacrylate, hexa functional polyester acrylate, dendritic polyester acrylate, carboxy polyester acrylate, fatty acid modified acrylate, and polyester methacrylate, but are not limited thereto.

According to another aspect of the present invention, a method of forming an image is provided, wherein a toner is attached on a surface of a photoreceptor in which an electrostatic latent image is formed to form a visible image and the visible image is transferred on a transfer medium. The toner is obtained by polymerizing a toner composition including a macromonomer to manufacture polymer latex particles, where the macromonomer has a hydrophilic group, a hydrophobic group and at least one reactive functional group, and at least one polymerizable monomer. The polymer latex particles are aggregated to obtain core particles. The core particles are coated with a dispersion solution to form a wax layer thereon, where the dispersion solution includes polymerizable monomers and a wax dispersed therein. A dispersion solution is formed by dispersing a pigment using the polymer latex particles which includes a wax layer and aggregating the pigment to obtain the toner.

An exemplary electrophotographic image forming process includes charging, exposure to light, development, transferring, fixing, cleaning, and erasure step, and a series of operation forming images on a receiving medium.

In the charging step, a photoreceptor is conventionally covered by a corona or charge roller with one of negative or positive charges. In the light exposing operation, an optical system, conventionally a laser scanner or a diode arrangement selectively discharges the surface charge of the photoreceptor in an imagewise manner corresponding to a desired image to be formed on a final image receptor to form a latent image. Electromagnetic radiation that can be referred to as “light” includes infrared ray radiation, visible light, and ultraviolet rays.

In the developing step, appropriate polar toner particles generally contact the latent image of the photoreceptor, and conventionally, an electrically-biased developer having identical potential polarity to the toner polarity is used. The toner particles move to the photoreceptor and are selectively attached onto the latent image by electrostatic electricity, and form a toned image on a photoreceptor.

In the transferring step, the toned image is transferred to the final image receptor from a photoreceptor, and sometimes, an intermediate transferring element is used following transferring of the toned image from the photoreceptor to transfer the toned image to the final image receptor.

In the fixing step, the toned image of the final image receptor is heated and the toner particles thereof are softened or melted, thereby fixing the toned image on the final image receptor. Another way of fixing is to fix the toner on the final receptor under high pressure with or without applying heat.

In the cleaning step, remaining toner on the photoreceptor is removed.

Finally, in the erasure step, charges of photoreceptor medium/body are exposed to light of a predetermined wavelength band and are reduced to a substantially uniform, low value, and thus the residue of the original latent image is removed, and a photoreceptor is prepared for a next image forming cycle.

According to another aspect of the present invention, an image forming apparatus is provided comprising: a unit for charging an organic photoreceptor and a surface of the organic photoreceptor; a unit for forming an electrostatic latent image on the surface of the organic photoreceptor; a unit for receiving toner; a unit for developing a toner image by supplying the toner to develop the electrostatic latent image of the organic photoreceptor; and a unit for transferring the toner image from the photoreceptor to the transferring medium. The toner is obtained by polymerizing a toner composition including a macromonomer to manufacture polymer latex particles, where the macromonomer has a hydrophilic group, a hydrophobic group, and at least one reactive functional group, and at least one polymerizable monomer. The polymer latex particles are aggregated to obtain core particles. The core particles are coated with a dispersion solution to form a wax layer thereon. The dispersion solution includes polymerizable monomers and a wax dispersed therein. A dispersion solution is formed by dispersing a pigment using the polymer latex particles which includes a wax layer and aggregating the pigment to obtain the toner.

FIG. 1 illustrates a non-contact developing type image forming apparatus using a toner prepared according to the method of the present invention. The operation of the non-contact developing type image forming apparatus is described below.

A non-magnetic one-component developing agent 8 in a developing apparatus 4 is supplied to a developing roller 5 by a supplying roller 6 formed of an elastic member such as polyurethane foam, sponge, and the like.

The developing agent 8 supplied to the developing roller 5 arrives at a contact portion of a developing agent regulation blade 7 and the developing roller 5 as the developing roller 5 rotates. The developing agent regulation blade 7 may be formed of an elastic member such as metal, rubber, and the like. The developing agent 8 passes through the contact portion of the developing agent regulation blade 7 and the developing roller 5 and is regulated to a predetermined thickness and becomes thin, and thus the developing agent 8 is sufficiently charged. The developing agent 8 regulated to the predetermined thickness is transferred to a developing region in which an electrostatic latent image of a photosensitive medium 1 is formed by the developing roller 5. At this time, the electrostatic latent image is formed by scanning light 3 to the photosensitive medium 1.

The developing roller 5 is separated a predetermined distance from and faces the photosensitive medium 1. The developing roller 5 may rotate in a counter-clockwise direction and the photosensitive medium 1 may then rotate in a clockwise direction.

The developing agent 8 transferred to the developing region of the photosensitive medium 1, develops an electrostatic latent image formed in the photosensitive medium 1 by an electric force generated by a potential difference of a voltage applied to the developing roller 5 from a power supply 12 and a potential of the latent image of the photosensitive medium 1 charged by a charging means 2 to form a toner image.

A toner image formed on the photosensitive medium 1 arrives at a transferring unit 9 according to the rotation direction of the photosensitive medium 1. A transfer bias voltage having an opposite polarity to the toner image is applied to the transferring unit 9 so that the toner image developed on the photosensitive medium 1 can be transferred to a printing medium 13. The toner image is transferred to the printing medium 13 by an electrostatic force between the photosensitive medium 1 and the transferring unit 9.

The toner image transferred to the printing medium 13 passes through a high temperature, high pressure fixing unit (not shown) and is fixed on the printing medium 13. Wasted developing agent 8′ which is not developed and remains in the developing roller 5 is collected by the supplying roller 6 which contacts the developing roller 5, and waste developing agent 8′ which is not developed and remains in the photosensitive medium 1 is collected by a cleaning blade 10. The above process is repeated.

The present invention will be described in more detail with reference to the examples below. However, the invention is not limited to these examples.

### EXAMPLE 1

The inside of the reactor was purged using nitrogen gas, and a mixture of 307 g of distilled deionized water and 0.5 g of poly(ethylene glycol)-ethyl ethermethacrylic acid (PEG-EEM, manufacture by Aldrich) was added to the reactor and agitated at 250 rpm and heated. When the temperature of the inside of the reactor approached 82° C., 0.2 g of potassium persulfate was melted in 20 g of deionized water and added to the reactor as a water soluble free radical initiator, and monomer mixture of styrene, n-butyl acrylate and methacrylic acid (mol ratio of 7:2:1, 10.5 g) and 0.2 g of 1-dodecanthiol, which is a chain transfer agent, were added into the reactor in a starved-feeding way and reacted for more than 2 hours. Separate from this, 15 g of ester wax was heated in a monomer mixture of styrene, n-butyl acrylate, and methacrylic acid (mol ratio of 6.9:2.3:0.8, 28.1 g) and 0.9 g of 1-dodecanthiol and slowly dissolved, and dispersed in a mixed solution of 190 g of distilled water and 1.45 g of HS-10 (manufactured by DAI-ICHI Kogyo Seiyahku Co., Ltd) to prepare a wax dispersion solution. The prepared wax dispersion solution was introduced into the reactor and 1 g of potassium persulfate was melted and dispersed in 40 g of deionized water and added into the reactor and reacted for 2 to 3 hours. Then, 1.3 g of potassium persulfate was melted and dispersed in 50 g of deionized water and input into the reactor, and 73.8 g of a monomer mixture of styrene, n-butyl acrylate and methacrylic acid (mol ratio of 7:2:1) and 2.2 g of 1-dodecanthiol were added to the reactor in a starved-feeding way and was reacted for 4 hours or more, and then were allowed to cool naturally. The size of polymer latex particles after reaction was 132 nm, and the conversion rate was about 98.8%.

200 g of obtained wax treated latex, 4 g of carbon black (Mogul L), and 106 g of deionized water were put in a disperser and dispersed for 2 hours at 7000 rpm to obtain a pigment dispersion solution having a particle size of 325 nm. The obtained pigment dispersion solution was moved to the reactor and cooled, and 20 g of MgCl₂ was dissolved in 20 g of deionized water as flocculant, and was heated at 95° C., and when the volume average particle size of the toner became about 7 μm, the resultant mixture was cooled and filtered to obtain toner particles.

### EXAMPLE 2

Toner particles having a toner volume average particle size of 6.8 μm were prepared in the same manner as Example 1 except that 4 g of cyan pigment (PB15:3) was used instead of carbon black as in Example 1.

### EXAMPLE 3

Toner particles having a toner volume average particle size of 7.8 μm were prepared in the same manner as Example 1 except that 4 g of magenta pigment (PR122/PR146) was used instead of carbon black as in Example 1.

### EXAMPLE 4

Toner particles having a toner volume average particle size of 7.7 μm were prepared in the same manner as Example 1 except that 4 g of yellow pigment (PY180) was used instead of carbon black as in Example 1.

### COMPARATIVE EXAMPLE 1

### Emulsion/Aggregation Process

1-1 Manufacture of Latex

3.0 g of SDS, which is a cationic surfactant, was mixed in 700 g of deionized water purged with nitrogen. 10.5 g of a monomer mixture of styrene, n-butyl acrylate and methacrylic acid (mol ratio of 6.8:2.7:0.5) and 3.0 g of 1-dodecanthiol were respectively mixed and added to a dropping funnel. The mixture of SDS and the deionized water was introduced into a reactor and was heated to 80° C. When the temperature reached 80° C., 1.0 g of potassium persulfate, as an initiator, was dissolved in 30 g of super-purified water and put into the reactor and agitated. After 10 minutes, 130 g of the prepared monomer mixture of styrene, n-butyl acrylate and methacrylic acid (mol ratio of 6.5:2.3:1.2) was added dropwise for 30 minutes. The reaction was continued for 6 hours, and then heating was stopped and the resultant mixture was allowed to cool naturally to obtain latex particles.

1-2 Toner Manufacture Aggregation/Melting Process

346 g of polymer latex particles prepared in this way were added to 307 g of super-purified water in which 2.0 g of SDS surfactant was dissolved and agitated. 18.2 g of a pigment particle aqueous solution dispersed with SDS surfactant (cyan 15:3, 40 weight %) and a wax dispersion solution dispersed in SDS surfactant were mixed. The mixed solution was agitated at 350 rpm, and pH of the latex pigment dispersion aqueous solution was adjusted to pH 10 using 10 % NaOH buffer solution. 30 g of super purified water was dispersed in 10 g of MgCl₂, which is a flocculant, and added dropwise to the latex pigment aqueous solution for about 10 minutes. The temperature was increased at the rate of 1° C./minute up to 95° C. The mixed solution was heated for 6 to 7 hours to obtain a desired size of the particles, and then the reaction was stopped and the mixed solution was allowed to cool naturally. The toner particle size obtained here had a diameter of about 10.5 μm on volume average.

### COMPARATIVE EXAMPLE 2

### Conventional Emulsion/Aggregation Process

2-1. Manufacture of Latex

0.5 g of SDS, which is a cationic surfactant, was mixed in 400 g of deionized water from which oxygen had been removed. 60 g of a monomer mixture of styrene, n-butyl acrylate and methacrylic acid (mol ratio of 6.7:2.5:0.6) was respectively mixed and added to a dropping funnel. The prepared aqueous solution was placed in a reaction bath and was heated to 80° C. When the temperature reached 80° C., an initiator solution was added in which 0.2 g of initiator potassium persulfate was dissolved in 30 g of super purified water. After 10 minutes, 30 g of a monomer mixture of styrene, n-butyl acrylate and methacrylic acid (mol ratio of 6.7:2.5:0.6) was added dropwise for about 30 minutes. The reaction was performed for 4 hours. After 4 hours, the heating was stopped, and the solution was allowed to cool naturally. 30 g of the seed solution manufactured in this manner was mixed in 351 g of super purified water and heated to 80° C. 17 g of ester wax was heated and dissolved with 18 g, 7 g, and 1.3 g of monomer mixture styrene, n-butyl acrylate and methacrylic acid and 0.4 g of 1-dodecanthiol. The wax/monomer mixture monomer prepared in this manner was added to 220 g of super purified water in which 3 g of SDS mixture monomer was dissolved, and homogenized for about 10 minutes. The homogenized emulsification solution was input into a reaction bath and then after 15 minutes, 5 g of potassium persulfate, which is the initiator, and 40 g of super purified water were dissolved and introduced to the reactor. The reaction temperature here was maintained at 82° C. and the reaction was performed for 2 hours and 30 minutes. After this reaction time of 2 hours and 30 minutes, again, 60 g of super purified water was added to 1.5 g of potassium persulfate and a mixed monomer was introduced for forming a shell layer. The composition of monomer was 56 g, 20 g, and 4.5 g of styrene, n-butyl acrylate, and methacrylic acid and 3 g of 1-dodecanthiol. The monomer was added dropwise for about 80 minutes. After the reaction time of 4 hours, the reaction was stopped, and the mixed solution was allowed to cool naturally.

2-2. Toner Manufacture Aggregation/Melting Process

318 g of the polymer latex particles prepared in this way were mixed in super purified water in which 0.5 g of SDS surfactant was dissolved. 18.2 g of pigment particle (cyan 15:3, 40 weight %) aqueous solution dispersed by surfactant was mixed. The mixture was agitated at 250 rpm, and pH of the latex pigment dispersion solution was adjusted to pH 10 using 10% of NaOH buffer. 30 g of super purified water was dissolved in 10 g of a flocculant MgCl₂, and then was added dropwise to the latex pigment aqueous solution for about 10 minutes. The temperature of the solution was increased at the rate of 1° C./minute up to 95° C. Then the mixed solution was heated for about 3 hours, and the reaction was stopped, and the mixed solution was allowed to cool naturally. The particle size obtained here had a diameter of 7.5 μm on average.

According to the present invention, polymer latex particles having dispersion ability were manufactured without using surfactant, and thus, the polymer latex particles are used to disperse a pigment to manufacture toner particles, thereby simplifying the process and increasing economical efficiency. Since no surfactant is used to produce the polymer latex particles, the washing process of the toner is simplified and the amount of the generated. wastewater is remarkably reduced, which is advantageous for environmental protection. The dispersion property and durability of the pigment in the toner can also be increased, and a toner having a small diameter and a small distribution of particle size can be easily manufactured, and storage stability can be improved, and fixing ability such as low temperature fixing property is improved. Also, cleaning of the toner in the printing process becomes easier and the transfer process can be improved, and the size and shape of the toner can be easily controlled.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a toner comprising:
manufacturing polymer latex particles by polymerizing a toner composition including a macromonomer having a hydrophilic group, a hydrophobic group, and at least one reactive functional group, and at least one polymerizable monomer;
manufacturing core particles by aggregating the polymer latex particles;
forming a wax layer on the core particles by coating the core particles with a dispersion solution that comprises at least one polymerizable monomer and a wax dispersed therein;
forming a pigment dispersion solution by dispersing a pigment using the polymer latex particles having the wax layer; and
aggregating the pigment dispersion solution to obtain the toner.

2. The method of claim 1, wherein the manufacturing and aggregating of the polymer latex particles are performed substantially in the absence of a surfactant.

3. The method of claim 1, wherein the forming of the pigment dispersion solution is performed substantially in the absence of a surfactant.

4. The method of claim 1, wherein the weight average molecular weight of the macromonomer is in the range of about 100 to 100,000.

5. The method of claim 1, wherein the macromonomer is selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide (PAM), polyethylene glycol (PEG)-hydroxyethylmethacrylate, hexa functional polyester acrylate, dendritic polyester acrylate, carboxy polyester acrylate, fatty acid modified acrylate, and polyester methacrylate.

6. The method of claim 1, wherein the content of the macromonomer is about 1 to 50 parts by weight based on 100 parts by weight of the total content of the toner composition.

7. The method of claim 1, wherein at least one polymerizable monomer is additionally added to the polymer latex particles having the wax layer to form a shell layer after the wax layer is formed.

8. The method of claim 1, wherein the polymerizable monomer is at least one monomer selected from the group consisting of a vinyl monomer, a polar monomer having a carboxylic group, a monomer having an unsaturated polyester group, and a monomer having a fatty acid group.

9. The method of claim 1, wherein the polymerizable monomer is at least one selected from the group consisting of styrene, vinyl toluene, μ-methyl styrene; acrylic acid, methacrylic acid, methyl acrylate, ethyl acrylate, propyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacryl amide; ethylene, propylene, butylene; vinyl chloride, vinylidene chloride, fluorinated vinyl; vinyl acetate, vinyl propionate; vinyl methyl ether, vinyl ethyl ether; methyl vinyl ketone, methyl isoprophenyl ketone; and 2-vinylpyridine, 4-vinylpyridine, and N-vinyl pyrolidone.

10. The method of claim 1, wherein the polymerizable monomer is selected from the group consisting of a styrene, a (meth)acrylate, an ethylenically unsaturated monoolefin, a vinyl ester, a vinyl ether, a vinyl ketone, and a nitrogen-containing vinyl compound.

11. The method of claim 1, wherein the forming of the polymer latex particles further includes using at least one selected from the group consisting of an initiator, a chain transfer agent, a charge control agent, and a release agent.

12. The method of claim 1, wherein the pigment is selected from the group consisting of yellow, magenta, cyan, and black pigments.

13. A toner manufactured according to the method of claim 1.

14. A toner obtained by polymerizing a toner composition including a macromonomer having a hydrophilic group, a hydrophobic group, and at least one reactive functional group, and at least one polymerizable monomer to produce polymer latex particles, aggregating the polymer latex particles to obtain core particles, coating the core particles with a dispersion solution to form a wax layer thereon, where the dispersion solution includes polymerizable monomers and a wax dispersed therein, and forming a dispersion solution by dispersing a pigment using the polymer latex particles having the wax layer and aggregating the pigment to obtain the toner.

15. The toner of claim 14, wherein the manufacturing and aggregating of the polymer latex particles are performed without the presence of a surfactant.

16. The toner of claim 14, wherein the average diameter of the toner particles is about 0.5 to 20 μm.

17. The toner of claim 14, wherein the macromonomer is selected from the group consisting of polyethylene glycol(PEG)-methacrylate, polyethylene glycol(PEG)-ethyl ether methacrylate, polyethylene glycol(PEG)-dimethacrylate, polyethylene glycol(PEG)-modified urethane, polyethylene glycol(PEG)-modified polyester, polyacrylamide (PAM), polyethylene glycol (PEG)-hydroxyethylmethacrylate, hexa functional polyester acrylate, dendritic polyester acrylate, carboxy polyester acrylate, fatty acid modified acrylate, and polyester methacrylate.

18. The toner of claim 14, wherein the toner includes at least one selected from the group consisting of an initiator, a chain transfer agent, a charge control agent, and a release agent.

19. A method of forming an image, the method comprising forming a visible image by attaching toner on a surface of a photoreceptive body on which a latent image is formed and transferring the visible image to a transferring member, wherein the toner is according to claim 14.

20. An image forming apparatus comprising: an organic photoreceptive body, a unit for charging a surface of the organic photoreceptive body, a unit for forming a latent image on the surface of the organic photoreceptive body, a unit for receiving a toner, a unit for developing the toned image by developing a latent image on the surface of the organic photoreceptive body by supplying the toner, and a unit for transferring the toner image from the surface of the photoreceptive body to a transferring member, wherein the toner is a toner according to claim 14.

20. A method of producing a toner comprising:
polymerizing a polymerizable toner composition to obtain polymer latex particles wherein the polymer latex has hydrophilic regions and hydrophobic regions;
aggregating the polymer latex particles to produce core particles;
forming a wax layer on the core particles;
dispersing a pigment using the wax coated polymer latex core particles in a solution to form a pigment dispersion; and
aggregating the pigment dispersion to obtain the toner.

21. The method of claim 20, wherein the toner composition includes at least one polymerizable monomer and a macromonomer having a hydrophilic group, a hydrophobic group, and at least one functional reactive group to obtain the polymer particles having the hydrophobic regions and the hydrophilic regions.

22. The method of claim 21, wherein the macromonomer is present in an amount sufficient for the polymer latex particles to disperse the pigment in the pigment dispersion without the use of a surfactant.

23. The method of claim 21, the method further comprising forming a wax dispersion of at least one polymerizable monomer and a wax, and admixing the wax dispersion with the core particles to form the wax layer on the core particles.
